(19) United States
(12) Patent Application Publication
(10) Pub. No.: US 2017/0006112 A1
(43) Pub. Date: Jan. 5, 2017

(54) COMMUNICATION SYSTEM, COMMUNICATION TERMINAL, MANAGEMENT SERVER, RECORDING MEDIUM, INFORMATION INQUIRY METHOD, INFORMATION RESPONSE METHOD, AND INFORMATION PROVISION METHOD

(71) Applicant: CASIO COMPUTER CO., LTD., Tokyo (JP)

(72) Inventor: Takahiro TOMIDA, Tokyo (JP)

(73) Assignee: CASIO COMPUTER CO., LTD., Tokyo (JP)

(21) Appl. No.: 15/039,845

(22) PCT Filed: Nov. 14, 2014
(86) PCT No.: PCT/JP2014/080249

§ 371 Date: May 26, 2016

(30) Foreign Application Priority Data
Dec. 20, 2013 (JP) 2013-263666

(51) Int. Cl. H04L 29/08; H04W 8/20; H04W 4/00

(52) U.S. Cl. CPC H04L 67/141; H04W 4/008; H04W 8/205; H04L 67/10; H04L 67/306

(57) ABSTRACT

A communication system includes a plurality of communication terminals and a management server. The communication terminal includes a wireless communication section which performs wireless communication with another communication terminal; a first communication section which performs communication with the management server; and a first sending control section which sends the first identification data received from the another communication terminal. The management server includes a storage section which stores profile data of each of users of the plurality of communication terminals; a second communication section which performs communication with the communication terminal; a second receiving control section which receives the first identification data; a response generation section which generates a response based on the profile data which corresponds to the first identification data; and a second sending control section which sends the response generated by the response generation section to the communication terminal by the second communication section.

### TECHNICAL FIELD

The present invention relates to a communication system, a communication terminal, a management server, a recording medium, a method of an information query from a communication terminal, a method of an information response from a management server, and a method of providing information.

### BACKGROUND ART

Some portable communication terminals including a smartphone and a game machine have short-range wireless communication functions such as Bluetooth (Registered Trademark), and can perform a data exchange with another communication terminal. The data exchange is possible even for a short time when the communication terminals pass by each other. Such a data exchange is called passing by communication (refer to, for example, Patent Documents 1 to 3).

On the other hand, communication tools using the Internet which are called SNS (Social Networking Service) are widely used.

By taking advantage of the passing by communication described above to exchange identification data such as an account name and a user ID of SNS, it is possible to provide a new opportunity for communicating with an unspecified user who happens to pass by.

### PRIOR ART DOCUMENT

### Patent Document

Patent Document 1: JP 2011-209872 A
Patent Document 2: JP 2012-151735 A
Patent Document 3: JP 2013-17726 A

### SUMMARY OF INVENTION

### Problem to be Solved by the Invention

However, even if the identification data of many users can be obtained through passing by communication, since the profile of each user is unknown, it is difficult to determine with which user to begin to communicate. In many cases, once an arbitrary user is selected to communicate with, communication cannot be continued due to a difference in directions (preferences) of users such as mismatch in hobbies.

If it is possible to know the user's profile in advance, communication can be started by selecting a user who shares direction (preference). However, disclosing the profile is related to personal privacy and some users want to avoid disclosing the profile if possible, and thus, the profile cannot be disclosed without limitation.

An object of the present invention is to provide an opportunity for communication while a user's profile is not disclosed more than necessary and the discrepancy in direction (preference) between users is decreased.

### Means for Solving the Problem

In accordance with one aspect of the present invention, to solve the above mentioned object, there is provided a communication system including:

a plurality of communication terminals; and

a management server, wherein the communication terminal includes:
a wireless communication section which performs
wireless communication with another communication terminal to receive first identification data to identify another communication terminal or a user of the another communication terminal;
a first communication section which performs communication with the management server; and
a first sending control section which sends the first identification data received from the another communication terminal by the wireless communication section to the management server by the first communication section,
wherein the management server includes:
a storage section which stores profile data of each of users of the plurality of communication terminals in association with identification data of each communication terminal or a user of each communication terminal;
a second communication section which performs communication with the communication terminal;
a second receiving control section which receives the first identification data from the communication terminal by the second communication section;
a response generation section which generates a response based on the profile data, among the profile data stored in the storage section, which corresponds to the first identification data received from the communication terminal by the second receiving control section; and
a second sending control section which sends the response generated by the response generation section to the communication terminal by the second communication section, and
wherein the communication terminal further includes a first receiving control section which receives the response from the management server by the first communication section.

### Effects of the Invention

In accordance with the present invention, providing a user of a communication terminal with a response with respect to the information based on a user's profile of another communication terminal is possible. A user can select another user who has the same hobby, for example, as a person to newly communicate with. Only identification data is disclosed from another communication terminal. The response provided by the management server is not all the profile of another user, but the information based on the profile. Thus, providing an opportunity for communication is possible while a user's profile is not disclosed more than necessary and the discrepancy in directions (preferences) between users is decreased.

### BRIEF DESCRIPTION OF DRAWINGS

FIG. 1 is a schematic diagram of a communication system according to the present invention.

FIG. 2 is a functional block diagram of a configuration of a communication terminal.

FIG. 3 is a timing diagram of a case where data is exchanged without establishing a connection in accordance with BLE (Bluetooth Low Energy) communication protocol.

FIG. 4 is a format of communication data in accordance with BLE communication protocol.

FIG. 5 is a functional block diagram of a management server.

FIG. 6 is an example of profile data.

FIG. 7 is a flowchart showing processing of a communication terminal giving a query on a profile and a management server providing a response to the query.

FIG. 8 is an example of a query list.

### DESCRIPTION OF PREFERRED EMBODIMENTS

Hereinafter, embodiments of a communication system, a communication terminal, a management server, a recording medium, an information query method of the communication terminal, an information response method of the management server and an information provision method according to the present invention will be described with reference to the drawings.

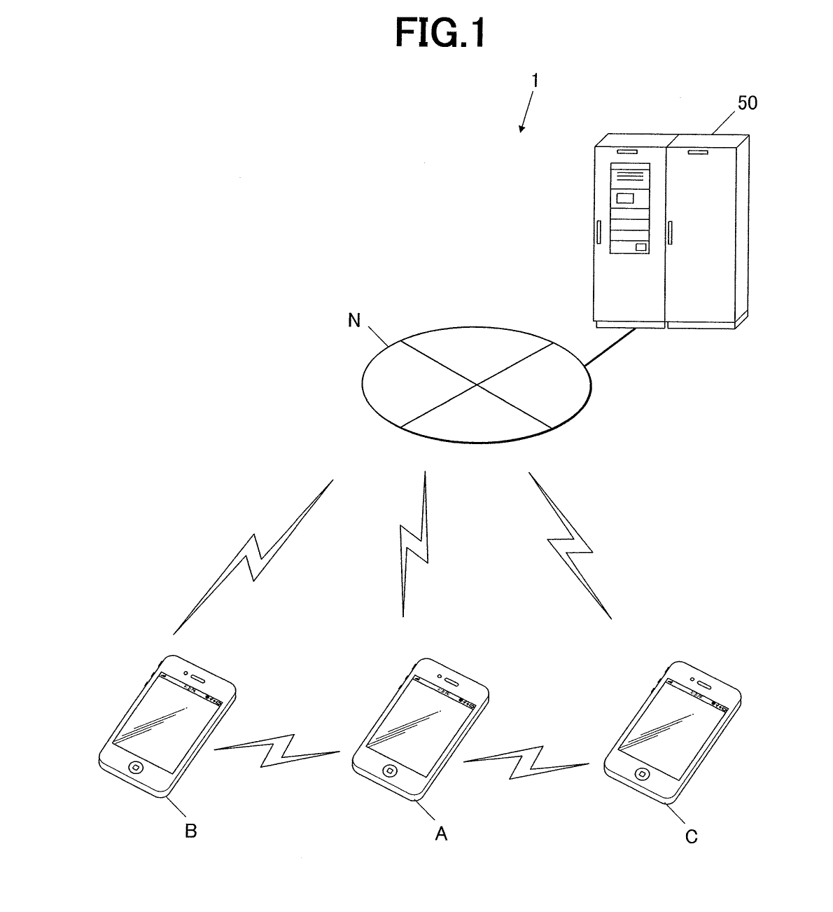

FIG. 1 shows a schematic configuration of a communication system 1 according to the present embodiment.

As shown in FIG. 1, the communication system 1 includes three communication terminals A, B and C and a management server 50. Each of the communication terminals A, B and C and the management server 50 are connected with each other via a network N such as the Internet.

The communication terminals A, B and C are smartphones each having a short-range wireless communication function, and can send to and receive from other communication terminals A, B and C communication data. The communication terminals A, B and C may be game machines, watches, pedometers (registered trademark) and data recording devices for running, if such portable communication terminals have similar wireless communication functions.

Since the communication terminals A, B and C have the same base configuration for exchanging communication data with each other through wireless communication, the communication terminal A will be described hereinafter as an example.

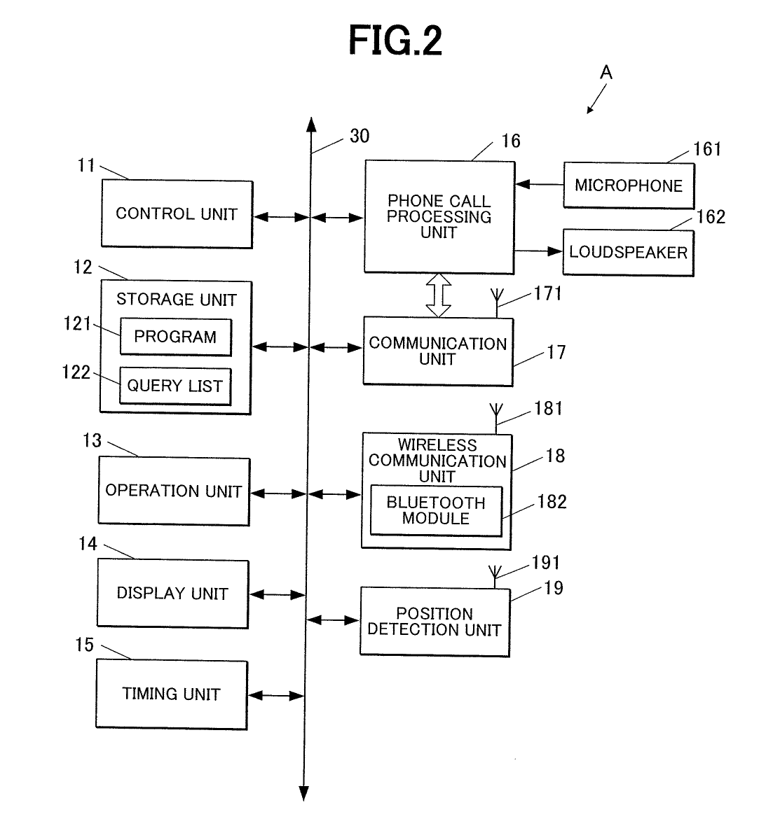

FIG. 2 is a functional block diagram showing a configuration of the communication terminal A by the functions thereof.

As shown in FIG. 2, the communication terminal A includes a control unit 11, a storage unit 12, an operation unit 13, a display unit 14, a timing unit 15, a microphone 161, loudspeaker 162, a phone call processing unit 16, a communication unit 17, a wireless communication unit 18 and a position detection unit 19, for example. Components of the communication terminal A are connected with each other via bus 30.

The control unit 11 includes a CPU (Central Processing Unit) and a RAM (Random Access Memory), for example. The control unit 11 reads a program 121 stored in the storage unit 12, and executes the program 121 to control the operation of each component of the communication terminal A.

For example, the control unit 11 executes a program for processing a phone call when a telephone call is instructed through the operation unit 13, and makes the phone call processing unit 16 and the communication unit 17 exchange speaking voice with the communication terminal B or C which is called.

In addition, the control unit 11 (a first receiving control section, a first sending control section, a query generation section) executes a query program to generate a query as to a user profile of another communication terminal B or C. The control unit 11 sends the generated query and identification data received from the other communication terminal B or C through the wireless communication unit 18 to the management server 50 through the communication unit 17. The communication unit 11 receives a response from the management server 50 through the communication unit 17.

The storage unit 12 stores the program 121 which can be read by the control unit 11 and data necessary for executing the program 121.

A recording medium such as a hard disk, an EEPROM (Electrically Erasable Programmable ROM) and a flash memory can be used for the storage unit 12.

The storage unit 12 (storage section) stores a query list 122 as is described in detail below. The query list 122 is a list which includes the identification data received from the other communication terminal B or C and queries to be sent to the management server 50 with the identification data.

The operation unit 13 includes operation keys and a touch panel, for example, and generates an operation signal in accordance with an operation thereof by a user and outputs the operation signal to the control unit 11.

The display unit 14 includes an LCD (Liquid Crystal Display), an organic EL (Electro Luminescence) display, or the like, and displays a display screen image such as an operation screen and a notification screen in accordance with a display control by the control unit 11.

The timing unit 15 carries out timing based on clock signals output from an oscillator and outputs current time

Speaking voice is input through the microphone 161.

The phone call processing unit 16 performs an A/D conversion of the speaking voice input by the microphone 161, performs an encoding to generate a base band signal of the speaking voice, and outputs to the communication unit 17. The phone call processing unit 16 performs a decoding of the base band signal of the speaking voice input by the communication unit 17 and performs a D/A conversion to output to the loudspeaker 162.

The loudspeaker 162 outputs the received voice.

The communication unit 17 includes an antenna 171 for RF (Radio Frequency) communication, and sends to and receives from a base station speaking voice and mail, for example, via the antenna 171

In the specific, the communication unit 17 demodulates the radio wave received via the antenna 171, and outputs the base band signal of the speaking voice and the packets of mail, for example, to the phone call processing unit 16 and the control unit 11, respectively. The communication unit 17 sends radio waves obtained by modulating the packets input from the control unit 11 or the base band signal input from the phone call processing unit 16 to the base station via the antenna 171.

The communication unit 17 can also perform sending and receiving via the network N by connecting to an access point of a wireless LAN (Local Area Network) through WiFi (Wireless Fidelity) (Registered Trademark).

The communication unit 17 (first communication section) sends the query generated by the control unit 11 and the identification data received by the wireless communication unit 18 to the management server 50 on the network N, and receives the response sent from the management server 50.

The wireless communication unit 18 (wireless communication section) includes an antenna 181 for Bluetooth and a Bluetooth module 182. The wireless communication unit 18 sends to and receives from another communication terminal B or C communication data by the Bluetooth module 182 through the antenna 181.

The communication standard for the wireless communication unit 18 is not limited to Bluetooth, but another communication standard such as Zigbee (Registered Trademark) may be adopted, if short-ranged wireless communication can be performed by such a standard.

The Bluetooth module 182 employs the communication protocol of BLE (Bluetooth Low Energy) for sending and receiving communication data.

The communication protocol of BLE alternates a sending mode and a receiving mode at regular intervals, wherein in the sending mode only sending communication data to another communication terminals B or C is performed and in the receiving mode only receiving communication data sent from another communication terminals B or C is performed. The sending mode is called Advertise and the receiving mode is called Scan.

The wireless communication unit 18 sends communication data to another communication terminal B or C in the sending mode and receives communication data from another communication terminal B or C in the receiving mode in accordance with the communication protocol of BLE in which the sending mode and the receiving mode are alternated.

In accordance with BLE, the communication data can be exchanged without establishing a connection.

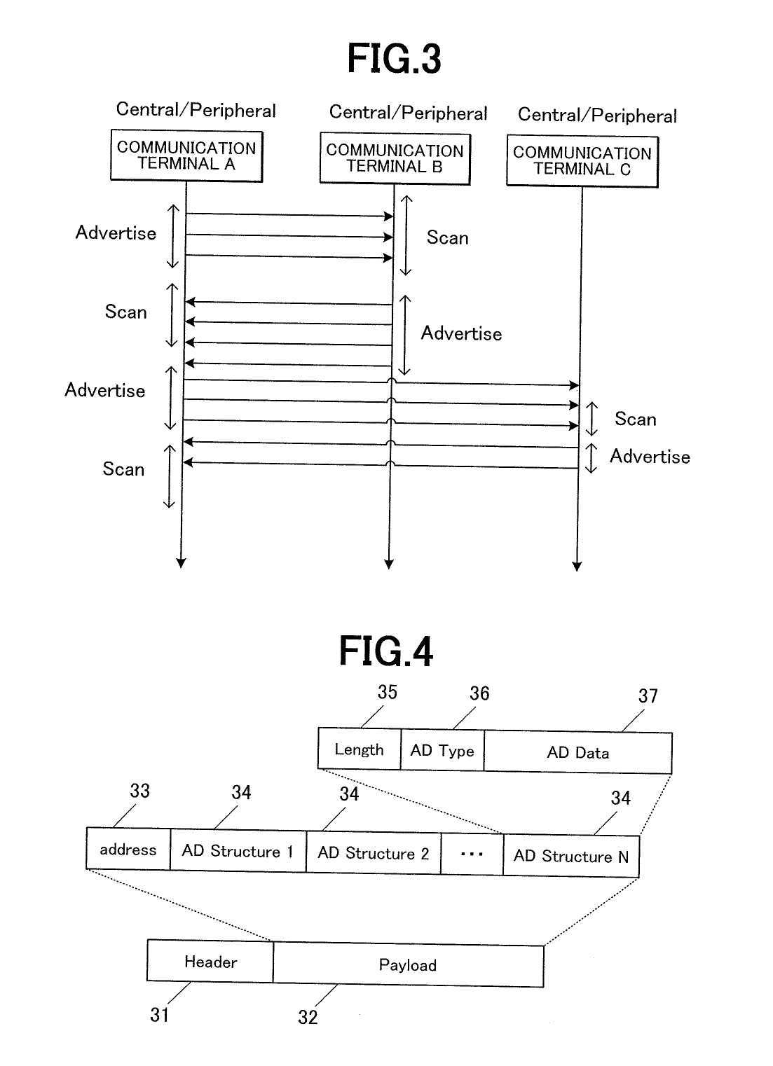

FIG. 3 is a timing chart in case where three communication terminals A, B and C exchange communication data without establishing connections therebetween.

As shown in FIG. 3, each of the communication terminals A, B and C alternates the sending mode shown by Advertise and the receiving mode shown by Scan, and alternately plays a role of Central and a role of Peripheral.

The wireless communication unit 18 switches the sending mode and the receiving mode at predetermined duration as shown in FIG. 3. In the specific, the wireless communication unit 18 includes a counter, and counts time by the counter to switch from the sending mode to the receiving mode and vice versa when the counted time reaches a switching timing.

The duration of the sending mode and the receiving mode can be set for each of the communication terminals A, B and C. Thus, if one of the communication terminals is in the sending mode and another of the communication terminals is in the receiving mode, the communication data can be sent and received. For example, when the sending mode of the communication terminal A and the receiving mode of the communication terminal B are overlapped, the communication terminal B can receive the communication data sent from the communication terminal A.

FIG. 4 shows the format of the communication data in BLE.

As shown in FIG. 4, the communication data is packet data composed of Header 31 and Payload 32. The Payload 32, which constitutes substantial data, is composed of an address 33 at the beginning of the Payload 32 and N AD structures N 34. The address 33 shows the addresses of the AD structure N 34.

Each of AD structure N 34 is composed of Length 35, AD Type 36 and AD Data 37. The Length 35 defines a data length of the AD Structure N 34. The AD Type 36 stores a flag which describes the kind of data which is stored in the AD Data 37. When the AD Type 36 stores the flag of 0xFF, the AD Data 37 can store specific data.

The specific data means any data which can be distributed to another communication terminal B or C without being restricted by BLE. Examples of data which can be stored in the AD Data 37 as the specific data include a message data set by a user for a distribution, a user ID issued in a service a user is using, user identification data on the communication terminal A such as an account name and the identification data of the communication terminal A specific to the communication terminal A such as a terminal ID.

The position detection unit 19 includes an antenna 191 for GPS (Global Positioning System), and receives radio waves from a plurality of GPS satellites through the antenna 191 to detect the current position of the communication terminal A by calculating the distance from each of the GPS satellites.

The management server 50 receives a query from each of communication terminals A, B and C, and sends a response to the query to each of the communication terminals A, B and C.

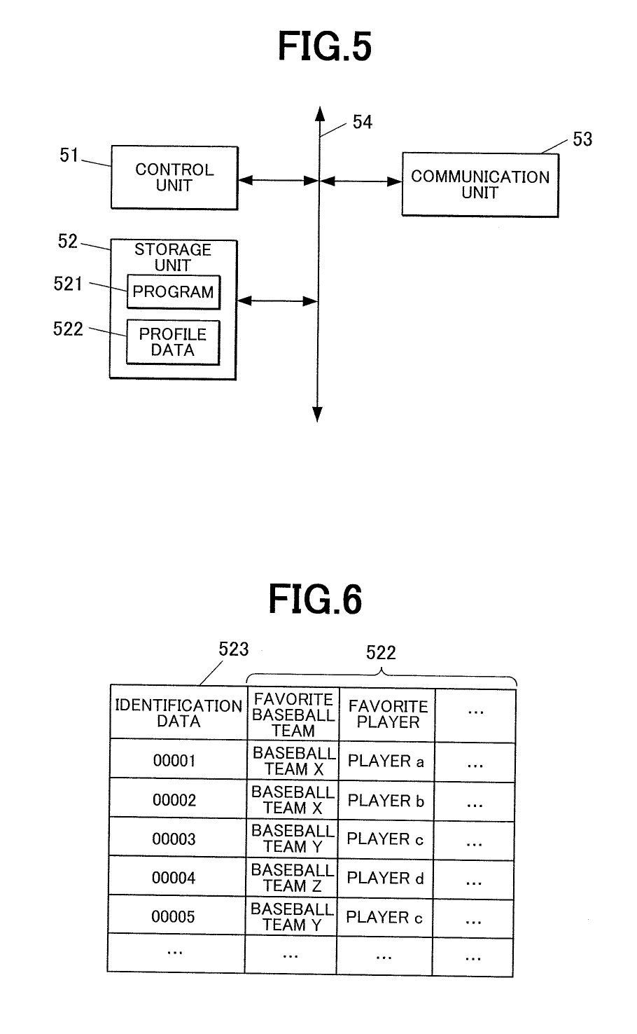

FIG. 5 is a functional block diagram showing a configuration of the management server 50 by the functions thereof.

As shown in FIG. 5, the management server 50 includes a control unit 51, a storage unit 52 and a communication unit 53. These components are connected with each other via bus 54.

The control unit 51 includes a CPU and a RAM, for example. The control unit 51 reads a program 521 stored in the storage unit 52, and controls the operation of each component of the management server 50 by executing the program 521.

The control unit 51 (a response generation section, second receiving control section, a second sending control section) obtains, among profile data 522 stored in the storage unit 52, the profile data 522 which corresponds to the identification data received from each of the communication terminals A, B and C by the communication unit 53. Based on the obtained profile data 522, the control unit 51 generates a response to a query received with the identification data. The control unit 51 sends through the communication unit 53 the generated response to the communication terminal A, B or C which sent the query.

The storage unit 52 stores the program 521 which can be read by the control unit 51 and data necessary to execute the program 521.

A recording medium such as a hard disk, an EEPROM and a flash memory can be used for the storage unit 52.

The storage unit 52 (a storage section) respectively stores the profile data 522 of the users of the communication terminals A, B and C in association with the communication terminals A, B and C or the identification data of the users of the communication terminals A, B and C.

The identification data may be, for example, a user ID Or an account name issued from a service such as SNS and a community site which the user is using or a terminal ID for identifying the communication terminal A, B or C the user is using, if such identification data can be used for identifying each user.

As the profile data 522, the data of, for example, the user's sex, age, profession, the name of an organization the user belongs to, hobby, favorite sports, favorite food may be cited. These data are uploaded onto the management server 50 and stored in the storage unit 52 as the profile data 522 when the user joins a service such as SNS described above.

FIG. 6 shows examples of the profile data 522 of the users who use a community site regarding baseball.

As is shown in FIG. 6, the profile data 522 about the name of each user's favorite baseball team and the name of each user's favorite player, for example, are stored in the storage unit 12 in association with the identification data 523. The identification data 523 shown in FIG. 6 are each user's user ID issued from the community site.

The communication unit 53 (a second communication section) includes a communication interface such as a network interface card, and performs communication with each of the communication terminals A, B and C on the network N.

Each one of the communication terminals A, B and C sends a query on a user's profile to the management server 50 by using the identification data of the user sent from another of the communication terminals A, B and C, thereby can obtain a response from the management server 50.

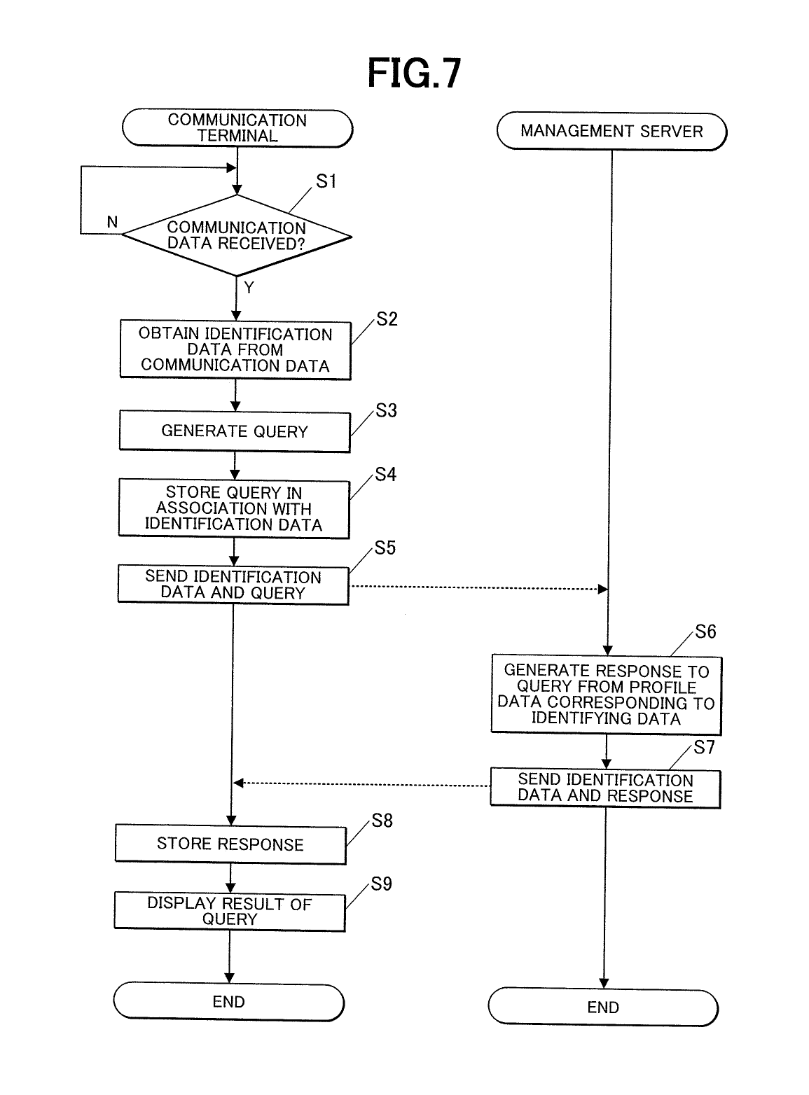

Although a processing in which the communication terminal A sends a query and the management server 50 sends a response will be described with reference to FIG. 7, the communication terminal B and C can also send a query similarly to the communication terminal A.

As shown in FIG. 7, when the wireless communication unit 18 of the communication terminal A is in the receiving mode and receives communication data from another communication terminal B or C (Step S1; Y), the control unit 11 obtains identification data of a user of the other communication terminal B or C from the communication data (Step S2). Since the identification data is stored in the AD Data 37 shown in FIG. 4, the control unit 11 can obtain the identification data by reading the AD Data 37 of the communication data.

Next, the control unit 11 generates a query regarding the user's profile (Step S3).

The query may be a query such as “What is you age?” to ask about a part of the user's profile. However, the control unit 11 preferably generates a query regarding the profile which requests a positive response or a negative response. Thereby, the query is made concrete and the direction (preference) of the user becomes more narrowed down. In addition, the profile can be disclosed as minimally as possible.

Examples of queries which request a positive response or a negative response include “Is your favorite baseball team X?” and “Is your favorite player a?”, for example. Such a query can be generated by applying a keyword prepared in advance such as a baseball team and a player to a blank of a template of the query such as “Is your favorite * *?” (where * represents a blank). The control unit 11 applies a keyword prepared in advance or lets a user select such a keyword.

The control unit 11 writes the generated query and the obtained identification data in the query list 122 so as to be associated with each other and stores the query list 122 in the storage unit 12 (Step S4)

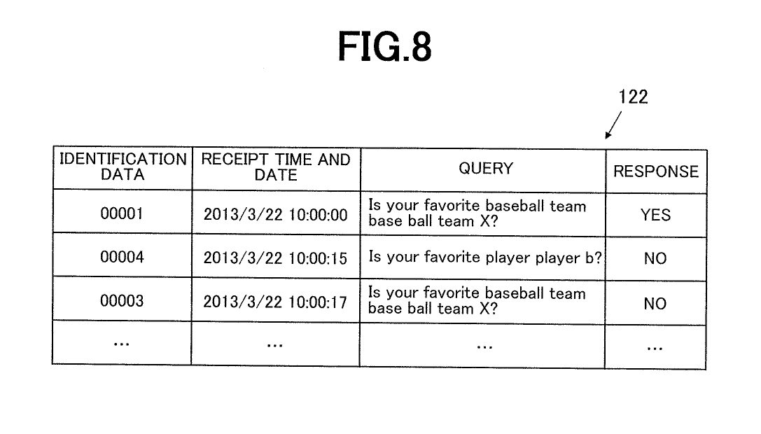

FIG. 8 shows an example of the query list 122. As is shown in FIG. 8, the query list 122 includes items of the identification data, received date and time, query and response.

The control unit 11 writes the obtained identification data and query in corresponding items. The control unit 11 also obtains current date and time from the timing unit 15 when receiving the identification data and writes the current date and time in the item of received date and time. When the management server 50 sends a response to the query, the response is written in the item of a response.

The control unit 11 sends the stored query and identification data to the management server 50 through the communication unit 17 (Step S5).

When the communication unit 53 of the management server 50 receives the query and identification data from the communication terminal A, the control unit 51 reads from the storage unit 52 the profile data corresponding to the identification data. The control unit 51 generates a response to the received query based on the profile data which is read (Step S6).

The control unit 51 generates a positive or negative response to a query which requests a positive or negative response. In the specific, the control unit 51 extracts a keyword from the query. The control unit 51 generates a positive response “Yes” if there is profile data which coincides with the extracted keyword among the profile data read out. On the other hand, the control unit 51 generates a negative response “No” if there is not profile data which coincides with the extracted keyword.

For example, in case where the identification data is “0001” and the query is “Is your favorite baseball team baseball team X?”, the control unit 51 reads the profile data 522 corresponding to the identification data “0001” from the storage unit 52. The control unit 51 extracts keywords such as “baseball team” and “baseball team X” from the query. Since there is the profile data “baseball team X” which coincides with the extracted keyword in the profile data 522 of the identification data “0001” shown in FIG. 6, the control unit 51 generates a response “Yes”.

In response to a query such as “What is your favorite sport?” and “What is your age?” which cannot be responded by a positive or negative response, the control unit 51 can generate a response such as “Baseball” and “25 years old” by reading the profile data corresponding to a keyword such as “favorite sport” and “age”.

In this way, in the case of a query which cannot be responded only by a positive or negative response, a part of a user's profile becomes a response. In order not to disclose the user's profile itself even partially, when the received query is not a query which does not request a positive or negative response, the control unit 51 may refuse a response and notify a refusal of a response to the communication terminal A which sent the query.

For example, when a response “baseball” is sent to another user who likes soccer in response to a query “What is your favorite sport?”, the profile that the favorite sport is baseball is disclosed to the other user whose favorite sport is different. If such a disclosure of the profile is not desirable, it is possible to prevent the profile from being disclosed to the other user with whom a user does not wish to communicate by refusing a response as described above.

The control unit 51 sends the generated response to the communication terminal A through the communication unit 53 (Step S7).

When the communication unit 17 of the communication terminal A receives the response and identification data sent from the management server 50, the control unit 11 associates the received response with the identification data and stores the received response in the query list 122 (Step S8).

The control unit 11 displays the received response by the display unit 14 as a result of the query (Step S9). The display unit 14 may display “There is a user who likes baseball team X” or may also display “User ID: 0001 likes baseball team X” in association with the identification data.

As described above, the communication system 1 according to the present embodiment includes the plurality of communication terminals A, B and C and the management server 50. The communication terminal A includes the wireless communication unit 18 which sends to and receives from another communication terminal B or C a user's identification data of each of the communication terminals A, B and C by wireless communication, the communication unit 17 which carries out communication with the management server 50, and the control unit 11 which generates a query on the profile of the user of another communication terminal B or C and which sends through the communication unit 17 to the management server 50 the query and the identification data received from another communication terminal B or C by the wireless communication unit 18. The management server 50 includes a storage unit 52 which stores the profile data 522 of each user of the plurality of communication terminals A, B and C in association with the identification data of each user, the communication unit 53 which communicates with the communication terminals A, and C, and the control unit 51 which generates a response to the query received with the identification data based on the profile data 522 corresponding to the identification data received from the communication terminals A, B and C by the communication unit 53, the profile data 522 being stored in the storage unit 52, and which sends the response to the communication terminals A, B and C through the communication unit 53.

It is possible to provide the user of the communication terminal A with a response to a query on the profile of the user of another communication terminal B or C. Based on the response, the user of the communication terminal A can select the user of another communication terminal B or C who has a common hobby, for example, as a person to newly communicate with. Only the identification data is directly disclosed by another communication terminal B or C. The response provided by the management server 50 is not all of the profile of another user, but only the profile inquired by the query. Thus, the user's profile is not disclosed more than needed, the inconsistency of the direction (preference) of the users is reduced, and opportunities of communication can be provided.

In the embodiment described above, the control unit 11 of the communication terminal A may send only the identification data of another communication terminal B or C (or the identification data of the user thereof) to the management server 50, and the control unit 51 of the management server 50 may generate a response based on the profile data 522 corresponding to the received identification data to send to the communication terminal A. For example, the control unit 51 of the management server 50 can read only items concerning a hobby from the profile data 522 and can generate a response such as “I like baseball”. Also, the control unit 51 of the management server 50 can also generate a response as to whether the direction of the profile data 522 corresponding to respective identification data coincide with each other. For example, the control unit 51 can generate a response such as “same hobby” when the contents described in the item concerning a hobby of the profile data 522 coincide with each other, and can generate a response such as “The degree of coincidence of the profile is 80%” by comparing all the items in the profile data 522.

In the embodiment described above, the control unit 11 of the communication terminal A generates a query requesting a positive or negative response with respect to the profile of the user of another communication terminal B or C.

The control unit 51 of the management server 50 generates a positive or negative response to the query.

Therefore, a response to a specific query can be obtained and directions (preferences) of the users can be further narrowed down. In addition, the profile is not disclosed more than needed, and thus, personal privacy can be protected.

In the embodiment described above, when the communication unit 17 receives the identification data and query from the communication terminals A, B and C, the control unit 51 of the management server 50 generates the response and sends the response to the communication terminals A, B and C.

Therefore, each time the identification data is received, a response to the query can be obtained.

The wireless communication unit 18 of the communication terminal A sends to and receives from another communication terminal B or C in accordance with a communication protocol in which the sending mode and the receiving mode are alternated at regular intervals wherein only sending communication data to another communication terminal B or C is carried out in the sending mode and only receiving data from another communication terminal B or C is carried out in the receiving mode.

The wireless communication unit 18 switches the sending mode and the receiving mode at a predetermined timing.

Therefore, it is possible to send to and receive from another communication terminal B or C the identification data during a short time when passing by another communication terminal B or C without establishing a connection.

The communication protocol descried above is Bluetooth Low Energy.

Therefore, the power consumption is suppressed.

The embodiment described above is a preferable example of the present invention and the present invention is not limited thereto, and may be modified as appropriate without departing from the spirit of the present invention.

For example, the number of times the control unit 11 of the communication terminal A generates queries on a user's profile using the same identification data to send to the management server 50 may be limited. By limiting the number of times of the queries, disclosing a user's profile more than needed can be limited due to a repetition of queries. From the viewpoint of privacy protection, the number of times of the query is preferably only once.

In the embodiment described above, the communication terminal A includes the storage unit 12 which stores the identification data received by the wireless communication unit 18 and a query generated by the control unit 11 so as to be associated with each other. The control unit 11 can make the identification data and query stored in the storage unit 12 be sent to the management server 50.

Therefore, the control unit 11 obtains current date and time from the timing unit 15 or the management server 50, and when the obtained current date and time reaches a predetermined date and time, the control unit 11 can send the queries corresponding to pieces of the identification data which have been stored in the storage unit 12 until then all together instead of when the communication data is received.

Also, the control unit 11 counts the number of pieces of the identification data stored in the query list 122, and when the counted number reaches a predetermined number, the control unit 11 can send the queries corresponding to pieces of the identification data which have been stored in the storage unit 12 until then all together.

Similarly, the control unit 11 can send the queries all together at the time designated by a user.

Although some embodiments of the present invention have been explained, the scope of the present invention is not limited to the embodiments described above, and includes the scope equivalent to the invention recited in the claims.

### INDUSTRIAL APPLICABILITY

In the technology to provide information between communication terminals, it is possible to make the communication between users more active and to apply to an application to protect individual information.

### DESCRIPTION OF REFERENCE NUMERALS

1 communication system
A, B, C communication terminal
11 control unit
12 storage unit
122 query list
15 timing unit
17 communication unit
18 wireless communication unit
19 position detection unit
50 management server
51 control unit
52 storage unit
522 profile data

1-19. (canceled)

20. A communication system comprising:
a plurality of communication terminals; and
a management server,
wherein the communication terminal comprises:
a wireless communication section which performs wireless communication with another communication terminal to receive first identification data to identify another communication terminal or a user of the another communication terminal;
a query generation section which generates a query which requests a positive response or a negative response with respect to preference of the user of the another communication terminal;
a first communication section which performs communication with the management server; and
a first sending control section which sends the first identification data received from the another communication terminal by the wireless communication section and the query generated by the query generation section to the management server by the first communication section,
wherein the management server comprises:
a storage section which stores profile data of each of users of the plurality of communication terminals in association with identification data of each communication terminal or a user of each communication terminal;
a second communication section which performs communication with the communication terminal;
a second receiving control section which receives the first identification data and the query from the communication terminal by the second communication section;
a response generation section which generates a positive response or a negative response to the query received with the first identification data based on the profile data, among the profile data stored in the storage section, which corresponds to the first identification data received from the communication terminal by the second receiving control section; and
a second sending control section which sends the response generated by the response generation section to the communication terminal by the second communication section, and
wherein the communication terminal further comprises a first receiving control section which receives the response from the management server by the first communication section.

21. The communication system according to claim 20, wherein:
the response generation section generates the response when the second receiving control section receives the first identification data and the query from the communication terminal; and
the second sending control section sends the response generated by the response generation section to the communication terminal.

22. The communication system according to claim 20, wherein:
the communication terminal comprises a storage section which stores the first identification data received by the wireless communication section and the query generated by the query generation section so as to associated with each other; and
the first sending control section sends the first identification data and the query which are stored in the storage section to the management server.

23. The communication system according to claim 22, wherein the first sending control section sends the first identification data and the query which are stored in the storage section to the management server at a set date and time.

24. The communication system according to claim 22, wherein the first sending control section sends the first identification data and the query which are stored in the storage section to the management server when a number of pieces of the first identification data stored in the storage section reaches a set number.

25. The communication system according to claim 20, wherein the wireless communication section receives communication data including the first identification data from the another communication terminal in accordance with a communication protocol in which a sending mode and a receiving mode are alternated, and wherein only sending the communication data to the another communication terminal is performed in the sending mode and only receiving the communication data sent from the another communication terminal is performed in the receiving mode.

26. The communication system according to claim 25, wherein the wireless communication section switches the sending mode and the receiving mode at a set time.

27. The communication system according to claim 26, wherein the communication protocol is Bluetooth Low Energy.

28. A communication terminal comprising:
a wireless communication section which performs wireless communication with another communication terminal to receive first identification data to identify another communication terminal or a user of the another communication terminal;
a query generation section which generates a query which requests a positive response or a negative response with respect to preference of the user of the another communication terminal;
a first communication section which performs communication with a management server which stores, in association with identification data of a plurality of communication terminals or users of a plurality of communication terminals, profile data of each user;
a first sending control section which sends the first identification data and the query generated by the query generation section to the management server by the first communication section, the first identification data being received from the another communication terminal by the wireless communication section; and
a first receiving control section which receives by the first communication section a positive response or a negative response generated by the management server based on the profile data corresponding to the first identification data in response to the query received with the first identification data.

29. A management server comprising:
a storage section which stores, in association with identification data of a plurality of communication terminals or users of a plurality of communication terminals, profile data of each user;
a second communication section which performs communication with the communication terminal;
a second receiving control section which receives from the communication terminal by the second communication section first identification data to identify a user of another communication terminal different from the communication terminal and a query which requests a positive response or a negative response with respect to preference of the user of the another communication terminal;
a response generation section which generates a positive response or a negative response based on the profile data, among the profile data stored in the storage section, which corresponds to the first identification data received from the communication terminal by the second receiving control section in response to the query received with the first identification data; and
a second sending control section which sends to the communication terminal the response generated by the response generation section by the second communication section.

30. A computer-readable recording medium having a program thereon which makes a computer of a communication terminal comprising a wireless communication section which performs wireless communication with another communication terminal to receive first identification data to identify another communication terminal or a user of the another communication terminal, and a first communication section which performs communication with a management server which stores, in association with identification data of a plurality of communication terminals or users of a plurality of communication terminals, profile data of each user, function as sections, comprising:
a query generating section to generate a query which requests a positive response or a negative response with respect to preference of the user of the another communication terminal;
a first sending control section to send the first identification data and the query generated by the query generation section to the management server by the first communication section, the first identification data being received from the another communication terminal by the wireless communication section; and
a first receiving control section to receive by the first communication section a positive response or a negative response generated by the management server based on the profile data corresponding to the first identification data in response to the query received with the first identification data.

31. A computer-readable recording medium having a program thereon which makes a computer of a management server comprising a storage section, in association with identification data of a plurality of communication terminals or users of a plurality of communication terminals, profile data of each user, and a second communication section which performs communication with the communication terminals, function as sections, comprising:
a second receiving control section to receive from the communication terminal by the second communication section first identification data to identify a user of another communication terminal different from the communication terminal and a query which requests a positive response or a negative response with respect to preference of the user of the another communication terminal;
a response generation section to generate a positive response or a negative response based on the profile data, among the profile data stored in the storage section, which corresponds to the first identification data received from the communication terminal by the second receiving control section in response to the query received with the first identification data; and
a second sending control section to send to the communication terminal the response generated by the response generation section.

32. An information query method performed by a communication terminal, comprising:
a wireless communication step to perform wireless communication with another communication terminal to receive first identification data to identify another communication terminal or a user of the another communication terminal;
a query generation step to generate a query which requests a positive response or a negative response with respect to preference of the user of the another communication terminal;
a first sending control step to send the first identification data and the query generated by the query generation step to the management server which stores, in association with identification data of a plurality of communication terminals or users of a plurality of communication terminals, profile data of each user, the first identification data being received from the another communication terminal by the wireless communication step; and
a first receiving control step to receive a positive response or a negative response generated by the management server based on the profile data corresponding to the first identification data in response to the query received with the first identification data.

33. An information response method performed by a management server comprising a storage section which stores, in association with identification data of a plurality of communication terminals and users of a plurality of communication terminals, profile data of each user, the method comprising:
a second receiving controlling step to perform communication with the communication terminal to receive from the communication terminal first identification data to identify a user of another communication terminal different from the communication terminal and a query which requests a positive response or a negative response with respect to preference of the user of the another communication terminal;
a response generation step to generate a positive response or a negative response based on the profile data, among the profile data stored in the storage section, which corresponds to the first identification data received from the communication terminal by the second receiving control step in response to the query received with the first identification data; and
a second sending control step to send to the communication terminal the response generated by the response generation step.

34. An information provision method performed between a plurality of information terminals and a management server which stores, in association with identification data of a plurality of communication terminals or users of a plurality of communication terminals, profile data of each user, the method comprising the steps of:
the communication terminal performing wireless communication with another communication terminal to receive a first identification data to identify another communication terminal or a user of the another communication terminal;
generating a query which requests a positive response or a negative response with respect to preference of the user of the another communication terminal;
the communication terminal sending the first identification data received from the another communication terminal and the query generated in the generating a query to the management server;
the management server generating a positive response or a negative response based on the profile data, among the profile data the management server stores, which corresponds to the first identification data received from the communication terminal in response to the query received with the first identification data;
the management server sending the response to the communication terminal; and
the communication terminal receiving the response from the management server.
